(19) United States
(12) Patent Application Publication
(10) Pub. No.: US 2026/0287723 A1
(43) Pub. Date: Sep. 24, 2026

(54) DEPTH SENSOR PERFORMANCE PREDICTION DEVICE AND OPERATING METHOD THEREOF

(71) Applicant: SK hynix Inc., Icheon-si (KR)

(72) Inventors: Ji Hee HAN, Icheon-si (KR); Ju Hyun CHO, Icheon-si (KR)

(21) Appl. No.: 19/315,339

(22) Filed: Aug. 29, 2025

(30) Foreign Application Priority Data
Mar. 18, 2025 (KR) 10-2025-0034715

(51) Int. Cl. G01S 7/487; G01S 7/4865; G01S 17/10; G01S 17/89

(52) U.S. Cl. CPC G01S 7/4873; G01S 7/4865; G01S 17/10; G01S 17/89

(57) ABSTRACT

A depth sensor performance prediction device is provided to include an estimator configured to estimate, based on input parameters, an error of depth values and generate a noise term corresponding to the error, and a predictor configured to receive the noise term from the estimator and predict a depth precision based on the noise term.

### CROSS-REFERENCE TO RELATED APPLICATION(S)

This patent document claims priority under 35 U.S.C. § 119 to Korean Patent Application No. 10-2025-0034715, filed on Mar. 18, 2025, the disclosure of which is incorporated herein by reference in its entirety.

### TECHNICAL FIELD

Various embodiments of the present disclosure relate to a semiconductor sensor devices and associated sensing operations including image sensing, and more particularly, to a depth sensor performance prediction device, and an operating method of the depth sensor performance prediction device.

### BACKGROUND

One way for measuring a distance of an object or subject is to use a “Light Detection and Ranging” laser device known as a UDAR which is one of depth sensors mainly used to measure a distance, i.e., a depth, to the object or subject by directing laser light from the UDAR towards to the object or subject which reflects the laser light back to the UDAR. The UDAR detects the reflected laser light from the object or subject and measures the time for the reflected light to return to the UDAR. Accordingly, such a LiDAR measures the time of flight (TOF) for the light to travel between the LiDAR and the object to determine distances at different locations of the object to the LiDAR. The LiDAR accumulates a hit count value of a laser, reflected and returned from the subject, in a plurality of time bins associated with the time of flight and measures the depth based on a time bin with the largest hit count value among the plurality of time bins.

In a prior art, it was possible to actually measure the depth using a depth sensor, which is completely manufactured, and evaluate the performance of the depth sensor based on the measurement result. In other words, in the prior art, there was a limit to evaluating the performance of the depth sensor in advance before the manufacture of the depth sensor was completed, and it was possible to evaluate the performance of the depth sensor only through the actual depth sensor after the manufacture of the depth sensor was completed.

### SUMMARY

Various embodiments of the present disclosure are directed to a depth sensor performance prediction device capable of predicting performance of the depth sensor, and an operating method of the performance prediction device.

In accordance with an embodiment of the present disclosure, a depth sensor performance prediction device may include: an estimator configured to estimate, based on input parameters, an error of depth values and generate a noise term corresponding to the error; and a predictor configured to receive the noise term from the estimator and predict a depth precision based on the noise term.

In accordance with an embodiment of the present disclosure, an operating method of a depth sensor performance prediction device may include: setting input parameters; estimating, based on the input parameters, an error of depth values; generating a noise term corresponding to the error; and predicting a depth precision based on the noise term.

### BRIEF DESCRIPTION OF THE DRAWINGS

FIG. 1 is a block diagram illustrating a depth sensor performance prediction device in accordance with an embodiment of the present disclosure.

FIG. 2 is a block diagram illustrating a depth sensor to additionally describe output light illustrated in FIG. 1.

FIG. 3 is a flowchart illustrating an operation of the depth sensor performance prediction device illustrated in FIG. 1.

FIG. 4 is a graph diagram illustrating a histogram mentioned in FIG. 3.

FIGS. 5a to 5c illustrate examples of tables showing a variability of a third parameter N based on some implementations of the disclosed technology.

FIGS. 6a to 6c illustrate examples of graphs showing relationships between a third parameter N and each of the first parameter σ, the second parameter a, and the distance.

FIGS. 7a to 7c illustrate examples of tables showing a variability of a fourth parameter b based on some implementations of the disclosed technology.

FIGS. 8a to 8c illustrate examples of graphs showing relationships between a fourth parameter b and each of the first parameter σ, the second parameter a, and the distance.

FIG. 9a to 9c illustrate examples of tables showing a variability of a photon noise based on some implementations of the disclosed technology.

FIGS. 10a to 10c illustrate examples of graphs showing relationships between a photon noise and each of the first parameter σ, the second parameter a, and the distance.

FIGS. 11a to 11c illustrate examples of tables showing a variability of a quantization noise based on some implementations of the disclosed technology.

FIGS. 12a to 12c illustrate examples of graphs showing relationships between a quantization noise and each of the first parameter, the second parameter a, and the distance.

FIGS. 13a to 13c illustrate examples of tables showing a variability of a background noise based on some implementations of the disclosed technology.

FIGS. 14a to 14c illustrate examples of graphs showing relationships between a quantization noise and each of the first parameter σ, the second parameter a, and the distance.

FIGS. 15a to 15c illustrate examples of tables showing a variability of a noise term NT based on some implementations of the disclosed technology.

FIGS. 16a to 16c illustrate examples of graphs showing relationships between a noise term and each of the first parameter σ, the second parameter a, and the distance.

### DETAILED DESCRIPTION

Various embodiments of the present disclosure are described below with reference to the accompanying drawings, in order to describe in detail some examples of the embodiments of the present disclosure.

It will be understood that when an element is described as being “connected to” or “coupled to” another element, the connection may be direct, or it may be indirect through one or more intervening elements, either physically or electrically. In addition, it will also be understood that the terms “comprises,” “comprising,” “includes,” and “including” when used in this specification do not preclude the presence of one or more other elements, but may further include or have the one or more other elements, unless otherwise mentioned. In the description throughout the specification, some components are described in singular forms, but the present disclosure is not limited thereto, and it will be understood that the components may be formed in plural.

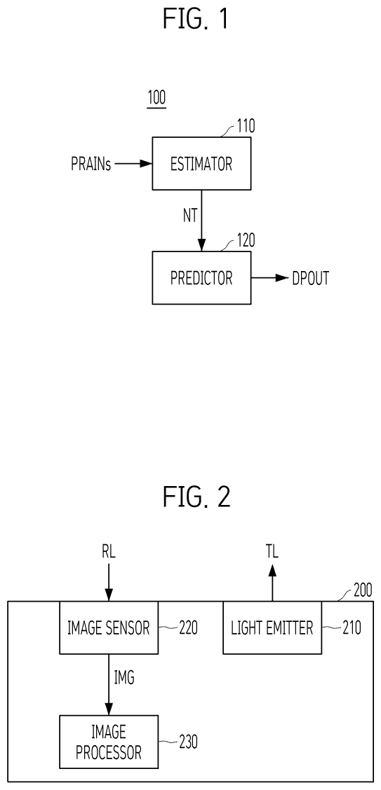

FIG. 1 is a block diagram illustrating a depth sensor performance prediction device 100 in accordance with an embodiment of the present disclosure.

Referring to FIG. 1, the depth sensor performance prediction device 100 may include an estimator 110 and a predictor 120.

The estimator 110 may estimate an error of corresponding depth values based on input parameters PRAINs and generate a noise term NT corresponding to the error. The depth values may be measured according to temporal variations. Thus, the depth values may be obtained by measuring a distance to a subject that varies over time.

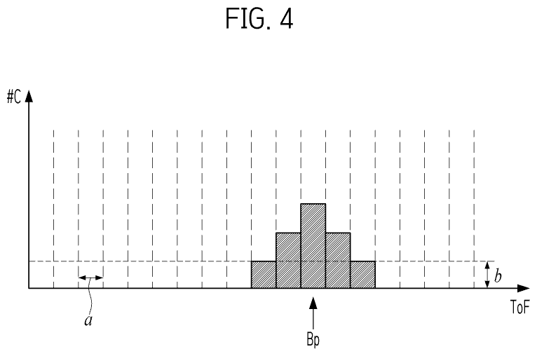

For example, the input parameters PRAINs may include first to fourth parameters σ, a, N and b. The first parameter σ may correspond to a pulse width of output light emitted to the subject. The output light is described in detail below with reference to FIG. 2. The second parameter a may correspond to a width of each of a plurality of time bins of a histogram used in measuring a depth. The histogram is described in detail below (see FIG. 4). The third parameter N may correspond to a sum of hit count values corresponding to at least one peak time bin among the plurality of time bins. The fourth parameter b may correspond to an average of other hit count values corresponding to other time bins excluding the peak time bin among the plurality of time bins. The first and second parameters a and a may be parameters that are set depending on a design of the depth sensor performance prediction device 100, and the third and fourth parameters N and b may be parameters that are set depending on experimental results. The input parameters PRAINs including the first to fourth parameters are preset values that are set in consideration of various factors including a design of the performance prediction device, characteristics of the depth sensor, environmental conditions, etc.

The predictor 120 may receive the noise term NT from the estimator 110 and predict a depth precision δ based on the noise term NT. The predictor 120 may generate a performance prediction signal DPOUT corresponding to the depth precision δ. The depth precision δ refers to the depth precision of a depth sensor that is a target of performance evaluation. The noise term NT may include at least one of photon noise, quantization noise, or background noise. In some implementations, when the noise term NT includes at least one of the photon noise, the quantization noise, or the background noise, which are related to the depth precision δ, the noise term NT refers to total noise of a sum of at least one of the photon noise, the quantization noise, or the background noise.

For example, the predictor 120 may predict the depth precision δ by reflecting the noise term NT in a predetermined prediction algorithm. The prediction algorithm may include Thompson's equation and is calculated by Equation 1 below.

$$δ = \sqrt{\frac{{σ}^{2} + {a}^{2} / 12}{N} + \frac{4 \sqrt{π} {σ}^{3} b}{a {N}^{2}}} \qquad [ Equation 1 ]$$

Herein, “σ²” may correspond to the photon noise, “a²/12” may correspond to the quantization noise, and

$$“ \frac{4 \sqrt{π} {σ}^{3} b}{a {N}^{2}} ”$$

may correspond to the background noise. The photon noise may be defined using the first parameter σ. The quantization noise may be defined using the second parameter a. The background noise may be defined using the first to fourth parameters σ, a, N and b.

FIG. 2 is a block diagram illustrating a depth sensor 200 based on some implementations of the disclosed technology. The output light as described above in relation to FIG. 1 will be described in more detail with reference to FIG. 2.

Referring to FIG. 2, the depth sensor 200 may include a light emitter 210, an image sensor 220, and an image processor 230.

The light emitter 210 may emit an output light TL to an external device. The output light TL may be a pulse signal having a predetermined pulse width or a periodic signal. For example, the light emitter 210 may include a vertical cavity surface emitting laser (VCSEL) driver. When the output light TL hits an object (not illustrated), the object illuminated by the output light TL from the light emitter 210 reflects or diffuses the output light to produce incident reflected light RL which may primarily include a portion of the output light TL that is reflected from the object.

The image sensor 220 may sense the incident reflected light RL and generate an input image IMG corresponding to the incident reflected light RL. The incident reflected light RL may be the reflected light reflected from the subject. The incident reflected light RL may appear as projected dots on the image sensor 220. The projected dots may be formed in a mesh form on the image sensor 200, and the image sensor 220 may generate the input image IMG having the projected dots.

The image processor 230 may receive the input image IMG and measure depth value(s) corresponding to the distance to the subject based on the projected dots.

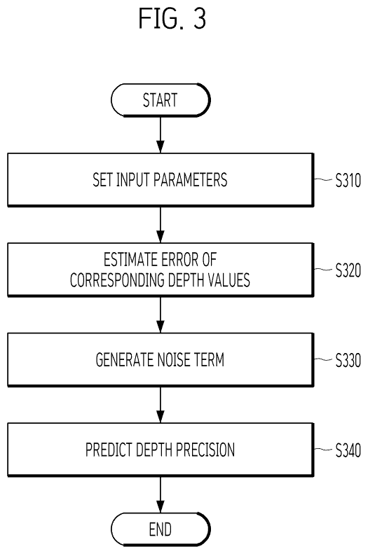

Hereinafter, an operation of the depth sensor performance prediction device 100 in accordance with an embodiment of the present disclosure, which has the above-described configuration, is described with reference to FIGS. 3 and 4.

Referring to FIG. 3, at step S310, the depth sensor performance prediction device 100 may set the input parameters PRAINs. The input parameters PRAINs may include the first to fourth parameters σ, a, N and b. The first parameter σ may correspond to a pulse width of the output light TL emitted to the subject. The second parameter a may correspond to a width of each of a plurality of time bins of a histogram used in measuring a depth. The histogram will be described in detail below with reference to FIG. 4. The third parameter N may correspond to a sum of hit count values corresponding to at least one peak time bin among the plurality of time bins. The fourth parameter b may correspond to an average of other hit count values corresponding to other time bins excluding the peak time bin among the plurality of time bins. Herein, the first and second parameters a and a may be parameters set depending on a design of the depth sensor performance prediction device 100, and the third and fourth parameters N and b may be parameters that are set depending on experimental results.

At step S320, the depth sensor performance prediction device 100 may estimate an error of corresponding depth values based on the input parameters PRAINs. At step S330, the depth sensor performance prediction device 100 may generate the noise term NT corresponding to the error. The depth values may be depth values measured according to temporal variations. Thus, the depth values may be obtained by measuring a distance to a subject that varies over time.

At step S340, the depth sensor performance prediction device 100 may predict the depth precision δ based on the noise term NT. The depth precision δ refers to the depth precision of the depth sensor that is a target of performance evaluation. The noise term NT may include at least one of photon noise, quantization noise, or background noise. For example, the depth sensor performance prediction device 100 may predict the depth precision δ by reflecting the noise term NT in the prediction algorithm.

FIG. 4 is an example of a graph diagram illustrating the histogram as discussed with reference to FIG. 3.

Referring to FIG. 4, the histogram represents accumulated hit count values #C corresponding to a plurality of time bins arranged according to the time of flight (ToF) which is the time duration for the light to travel between the subject illuminated to the output light TL from the light emitter 210 and the image sensor 220 as shown in FIG. 2. For example, the histogram may be a coarse histogram other than a fine histogram.

A width of each of the plurality of time bins may correspond to the second parameter a. A sum of hit count values corresponding to at least one peak time bin Bp among the plurality of time bins may correspond to the third parameter N. In FIG. 4, the at least one peak time bin Bp is illustrated as a single time bin having a greatest hit count values. Although FIG. 4 illustrates an example in which the at least one peak time bin Bp includes one time bin, the present disclosure is not necessarily limited thereto. For example, the at least one peak time bin Bp may include two or more upper peak time bins depending on a design. An average of other hit count values corresponding to other time bins excluding the peak time bin Bp among the plurality of time bins may correspond to the fourth parameter b.

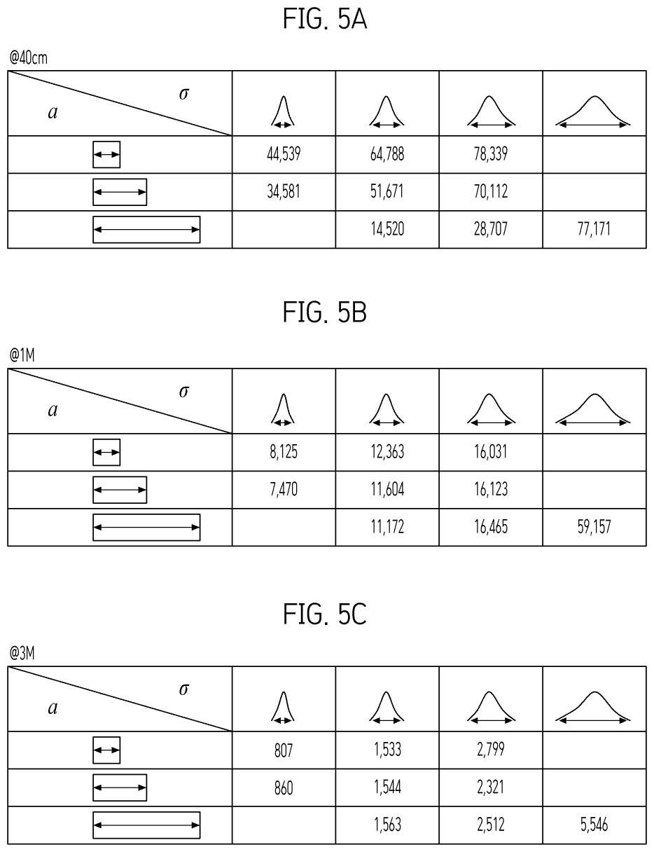

FIGS. 5a to 16c are diagrams illustrating experimental results related to some parameters and some noises, which are described in relation to FIG. 3.

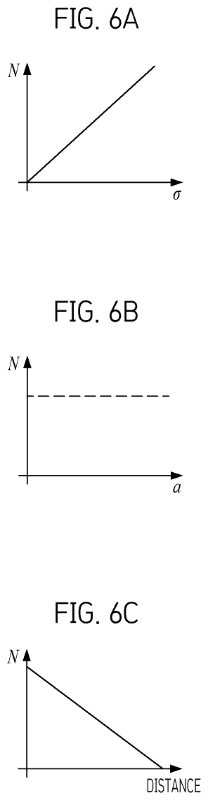

FIGS. 5a to 5c are tables illustrating variability of the third parameter N when the first parameter σ, the second parameter a and the distance to the subject vary. FIG. 5a shows a case when the distance to the subject is 40 cm, FIG. 5b shows a case when the distance to the subject is 1 meter (M), FIG. 5c shows a case when the distance to the subject is 3 meters (M). The numbers in each of FIGS. 5a to 5c indicate values of the third parameter N. FIGS. 6a to 6c are graph diagrams to show the relationships between the third parameter N and each of the first parameter σ, the second parameter a, and the distance, which are illustrated in FIGS. 5a to 5c.

Referring to FIGS. 5a and 6a, it may be seen that when the first parameter a increases, the third parameter N also increases. Referring to FIGS. 5b and 6b, when the second parameter a increases, the third parameter N remains generally constant. Referring to FIGS. 5c and 6c, as the distance to the subject increases (@40 cm<@1M<@3M), the third parameter N decreases.

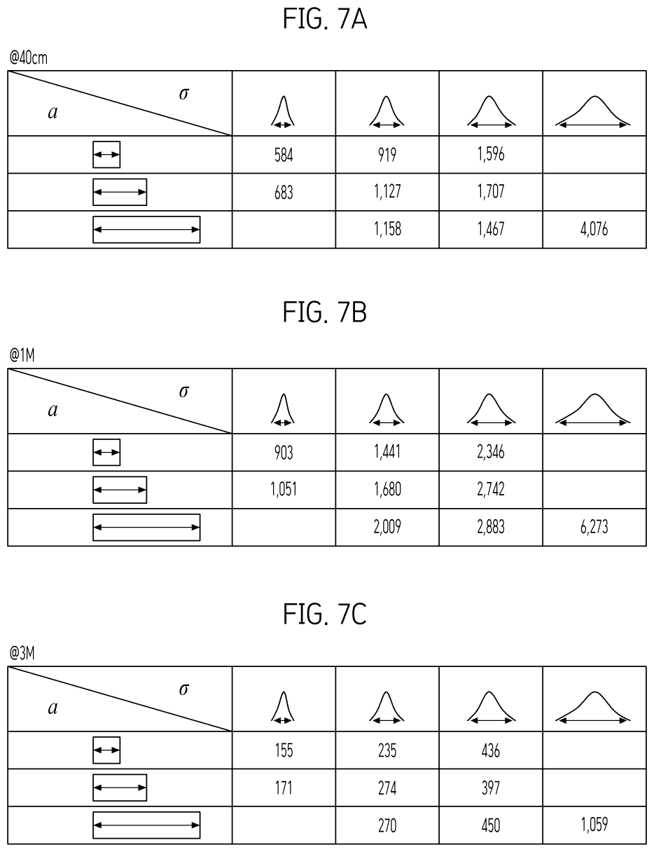

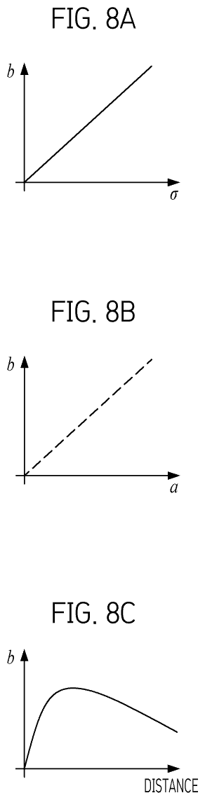

FIGS. 7a to 7c are tables illustrating variability of the fourth parameter b when the first parameter σ, the second parameter a and the distance to the subject vary. FIG. 7a shows a case when the distance to the subject is 40 cm, FIG. 7b shows a case when the distance to the subject is 1 meter (M), FIG. 7c shows a case when the distance to the subject is 3 meters (M). The numbers in each of FIGS. 7a to 7c indicate values of the fourth parameter b. FIGS. 8a to 8c are graph diagrams showing the relationship between the fourth parameter b and each of the first parameter σ, the second parameter a, and the distance, which are illustrated in FIGS. 7a to 7c.

Referring to FIGS. 7a and 8a, it may be seen that when the first parameter a increases, the fourth parameter b also increases. Referring to FIGS. 7b and 8b, when the second parameter a increases, the third parameter N generally increases. Referring to FIGS. 7c and 8c, as the distance to the subject increases (@40 cm<@1M<@3M), the third parameter N tends to decrease.

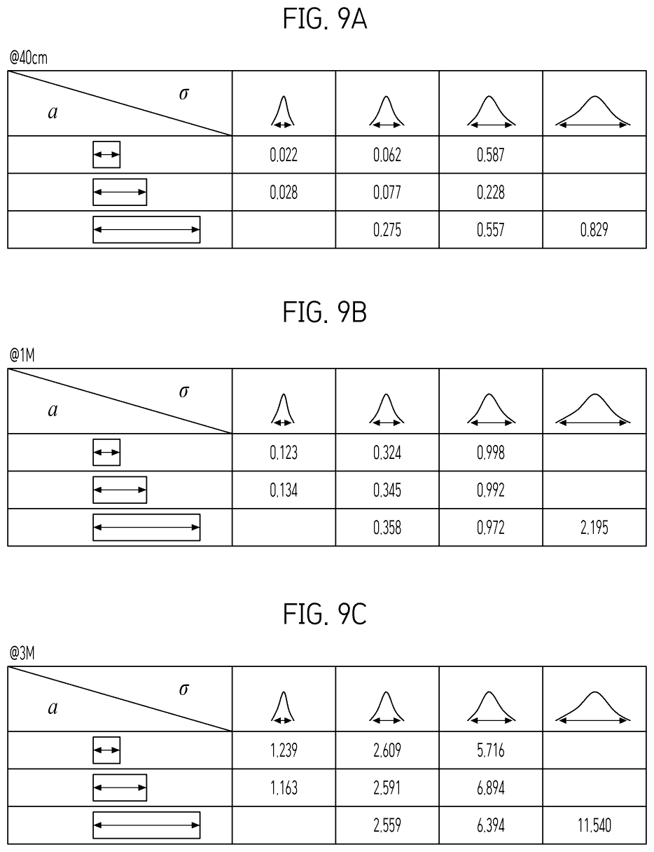

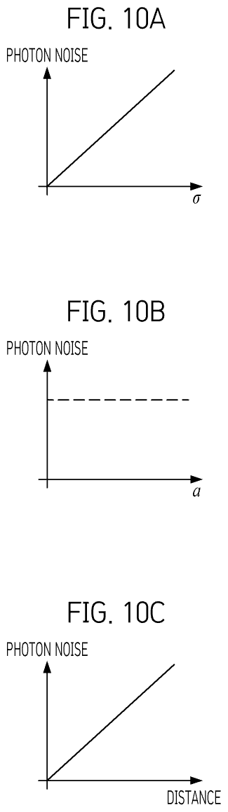

FIGS. 9a to 9c are tables illustrating variability of the photon noise when the first parameter σ, the second parameter a and the distance to the subject vary. FIG. 9a shows a case when the distance to the subject is 40 cm, FIG. 9b shows a case when the distance to the subject is 1 meter (M), FIG. 9c shows a case when the distance to the subject is 3 meters (M). The numbers in each of FIGS. 9a to 9c indicate values of the photon noise. FIGS. 10a to 10c are graph diagrams to show the relationships between the photon noise and each of the first parameter, the second parameter a, and the distance, which are illustrated in FIGS. 9a to 9c.

Referring to FIGS. 9a and 10a, it may be seen that when the first parameter σ increases, the photon noise also increases. Referring to FIGS. 9b and 10b, when the second parameter a increases, the photon noise remains generally constant. Referring to FIGS. 9c and 10c, as the distance to the subject increases (@40 cm<@1M<@3M), the photon noise increases.

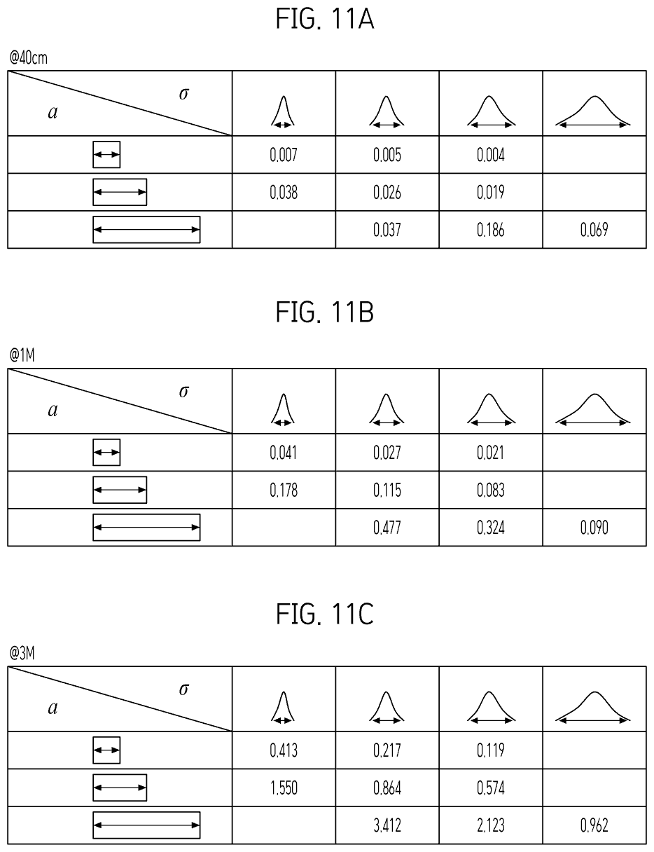

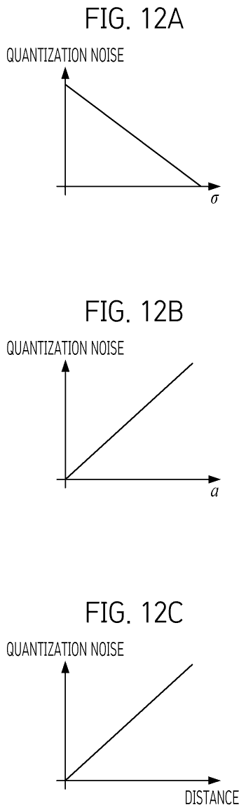

FIGS. 11a to 11c are tables illustrating variability of the quantization noise when the first parameter σ, the second parameter a and the distance to the subject vary. FIG. 11a shows a case when the distance to the subject is 40 cm, FIG. 11b shows a case when the distance to the subject is 1 meter (M), FIG. 11c shows a case when the distance to the subject is 3 meters (M). The numbers in each of FIGS. 11a to 11c indicate values of the quantization noise. FIGS. 12a to 12c are graph diagrams to show the relationships between the quantization noise and each of the first parameter, the second parameter a, and the distance, which are illustrated in FIGS. 11a to 11c.

Referring to FIGS. 11a and 12a, it may be seen that when the first parameter σ increases, the quantization noise decreases. Referring to FIGS. 11b and 12b, when the second parameter a increases, the quantization noise also increases. Referring to FIGS. 11c and 12c, as the distance to the subject increases (@40 cm<@1M<@3M), the quantization noise also increases.

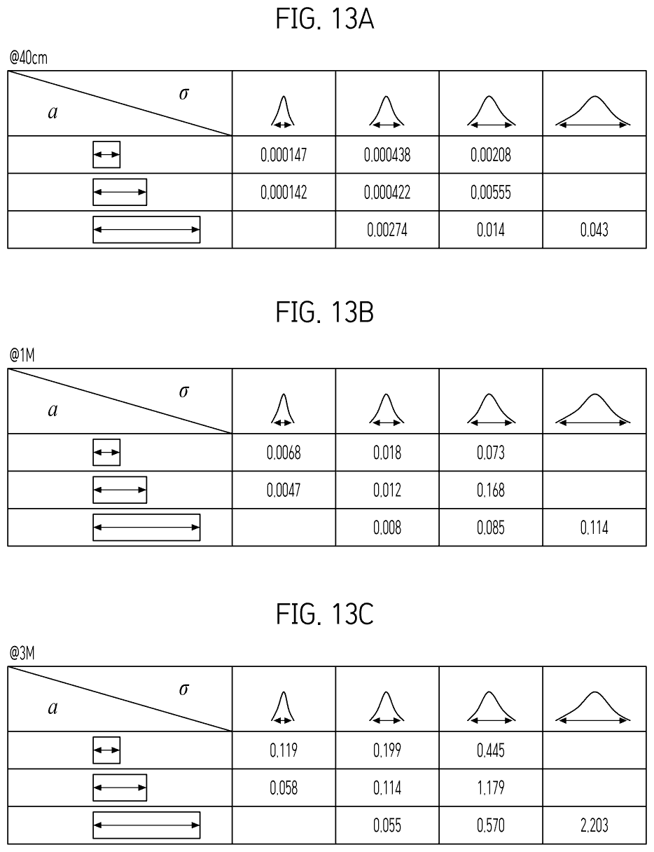

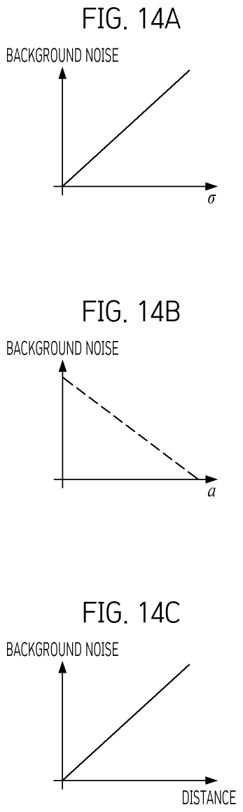

FIGS. 13a to 13c are tables illustrating variability of the background noise when the first parameter σ, the second parameter a and the distance to the subject vary. FIG. 13a shows a case when the distance to the subject is 40 cm, FIG. 13b shows a case when the distance to the subject is 1 meter (M), FIG. 13c shows a case when the distance to the subject is 3 meters (M). The numbers in each of FIGS. 13a to 13c indicate values of the background noise. FIGS. 14a to 14c graph diagrams showing the relationship between the background noise and each of the first parameter σ, the second parameter a, and the distance, which are illustrated in FIGS. 13a to 13c.

Referring to FIGS. 13a and 14a, it may be seen that when the first parameter σ increases, the background noise increases. Referring to FIGS. 13b and 14b, when the second parameter a increases, the background noise decreases. Referring to FIGS. 13c and 14c, as the distance to the subject increases (@40 cm<@1M<@3M), the background noise also increases.

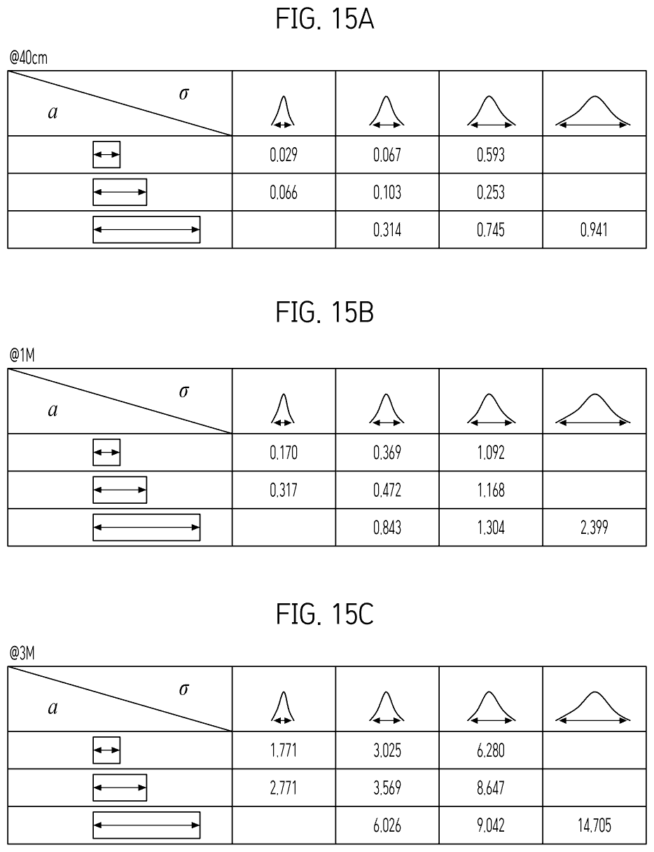

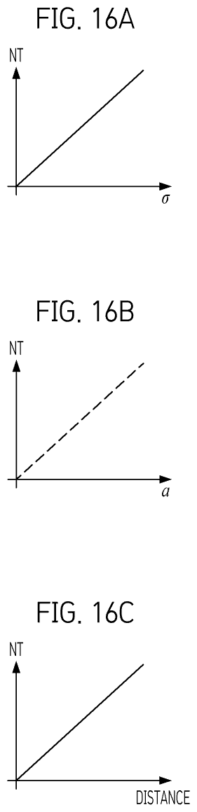

FIGS. 15a to 15c are tables illustrating variability of the noise term NT when the first parameter a, the second parameter a and the distance to the subject vary. FIG. 15a shows a case when the distance to the subject is 40 cm, FIG. 15b shows a case when the distance to the subject is 1 meter (M), FIG. 15c shows a case when the distance to the subject is 3 meters (M). The numbers in each of FIGS. 15a to 15c indicate values of the noise term NT. FIGS. 16a to 16c are graph diagrams to showing the relationship between the noise term NT and each of the first parameter σ, the second parameter a, and the distance, which are illustrated in FIGS. 15a to 15c.

Referring to FIGS. 15a and 16a, it may be seen that when the first parameter σ increases, the noise term NT also increases. Referring to FIGS. 15b and 16b, when the second parameter a increases, the noise term NT generally increases. Referring to FIGS. 15c and 16c, as the distance to the subject increases (@40 cm<@1M<@3M), the noise term NT also increases.

According to an embodiment of the present disclosure, as a noise term is defined and used as an indicator representing depth precision, the performance of a depth sensor to be designed may be predicted.

According to an embodiment of the present disclosure, the prediction of the performance of a depth sensor before the manufacture of the depth sensor is completed has the effect of helping to determine the direction of design of the depth sensor.

While various embodiments have been described with reference to the exemplified drawings, variations and improvements of the disclosed embodiments and other embodiments may be made based on what is described or illustrated in this document. Further, it is noted that the embodiments of the present disclosure may be achieved in various ways through substitution, change, and modification that fall within the scope of the following claims, as those skilled in the art will recognize in light of the present disclosure. The embodiments may be combined to form additional embodiments.

What is claimed is:

1. A depth sensor performance prediction device, comprising:
an estimator configured to estimate, based on input parameters, an error of depth values and generate a noise term corresponding to the error; and
a predictor configured to receive the noise term from the estimator and predict a depth precision based on the noise term.

2. The depth sensor performance prediction device of claim 1, wherein the input parameters include first to fourth parameters,
wherein the first parameter (σ) corresponds to a pulse width of output light emitted to a subject
the second parameter (a) corresponds to a width of each of a plurality of time bins of a histogram used in measuring a depth,
the third parameter (N) corresponds to a sum of hit count values corresponding to at least one peak time bin among the plurality of time bins, and
the fourth parameter (b) corresponds to an average of other hit count values corresponding to other time bins excluding the at least one peak time bin among the plurality of time bins.

3. The depth sensor performance prediction device of claim 2, wherein the first and second parameters are set depending on a design of the depth sensor performance prediction device, and
the third and fourth parameters are set depending on an experimental result.

4. The depth sensor performance prediction device of claim 1, wherein the depth values are predetermined depending on temporal variations.

5. The depth sensor performance prediction device of claim 1, wherein the noise term includes at least one of a photon noise, a quantization noise, or a background noise.

6. The depth sensor performance prediction device of claim 1, wherein the predictor is configured to predict the depth precision by reflecting the noise term in a prediction algorithm that is predetermined.

7. The depth sensor performance prediction device of claim 6, wherein the prediction algorithm includes Thompson's equation.

8. An operating method of a depth sensor performance prediction device, the operating method comprising:
setting input parameters;
estimating, based on the input parameters, an error of depth values;
generating a noise term corresponding to the error; and
predicting a depth precision based on the noise term.

9. The operating method of claim 8, wherein the input parameters include first to fourth parameters,
wherein the first parameter (σ) corresponds to a pulse width of output light emitted to a subject,
the second parameter (a) corresponds to a width of each of a plurality of time bins of a histogram used in measuring a depth,
the third parameter (N) corresponds to a sum of hit count values corresponding to at least one peak time bin among the plurality of time bins, and
the fourth parameter (b) corresponds to an average of other hit count values corresponding to other time bins excluding the at least one peak time bin among the plurality of time bins.

10. The operating method of claim 9, wherein the first and second parameters are parameters set depending on a design of the depth sensor performance prediction device, and
the third and fourth parameters are set depending on an experimental result.

11. The operating method of claim 8, wherein the depth values are predetermined depending on temporal variations.

12. The operating method of claim 8, wherein the noise term includes at least one of a photon noise, a quantization noise, or a background noise.

13. The operating method of claim 9, wherein the predicting of the depth precision includes predicting the depth precision by reflecting the noise term in a prediction algorithm that is predetermined.

14. The operating method of claim 13, wherein the prediction algorithm includes Thompson's equation.
